(19) United States
(12) Patent Application Publication
(10) Pub. No.: US 2001/0053274 A1
(43) Pub. Date: Dec. 20, 2001

(54) System and method for remote control of consumer electronics over data network with visual feedback

(75) Inventors: Gregory Robert Roelofs, San Jose, CA (US); Pieter Sierd Van der Meulen, Sunnyvale, CA (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/886,305

(22) Filed: Jun. 19, 2001

Related U.S. Application Data
(60) Provisional application No. 60/212,578, filed on Jun. 20, 2000.

(51) Int. Cl. H04N 5/445; H04N 5/91; G06F 3/00; H04N 7/00; G06F 13/00

(52) U.S. Cl. 386/46; 386/83; 725/37

(57) ABSTRACT

A CE device has a generator for generating data to create an on-screen menu for a GUI. These data is transferred via the Internet to a remote location where the user is given visual feedback for control of the apparatus. Control is achieved via the Internet and a home server driving an IR blaster local to the apparatus.

This application claims priority of U.S. provisional application Serial No. 60/212,578 entitled “Very Remote Control of a Legacy VCR” filed in the U.S. Patent and Trademark Office on Jun. 20, 2000, the contents of which are hereby incorporated by reference.

### BACKGROUND OF THE INVENTION

1. Field of the Invention

The present invention relates to remote control of consumer electronics (CE) equipment via a data network, such as the Internet, while receiving visual feedback.

2. Description of the Related Art

Remote control of CE apparatus is well known in the art. For example, a handheld remote control is used which transmits infrared (IR) or radio frequency (RF) signals to the CE apparatus. This control method limits a user to local control, typically requiring a user to be in the same room as the CE apparatus unless an IR or RF repeater arrangement is implemented.

IR transmitters, such as IR blasters, have also been implemented to control CE apparatus. An IR transmitter typically connects to a home PC by either a standard serial connection (RS-232), or by using X-10 signals via an X-10 interface module. The IR transmitter utilizes application software to learn the IR communication characteristics of any remote by pointing the remote at the IR transmitter, receiving a responsive signal that includes the IR communication characteristics, and storing the IR communication characteristics on the PC's hard drive. Once learned, the application software transmits the appropriate IR signal to the CE apparatus under the control of a user.

### SUMMARY OF THE INVENTION

However, there are several drawbacks to the arrangement discussed above. For example, when remotely controlling a VCR, a user may wish to view the on-screen menu of the VCR to allow the user to select commands via menu navigation. In such a case, the user must still be in view of a TV connected to the VCR to view the menu.

Additionally, a user may want to control the CE apparatus, with said on-screen menu (or, more generally, visual feedback from the CE apparatus), from a very remote location, such as an office. For example, a user may arrive at work realizing he/she forgot to set his/her VCR at home to record his/her favorite program. In such a case, remote control with visual feedback via a data network, such as the Internet, would be advantageous.

Therefore, a need exists for a system and method to remotely control CE apparatus over a data network while receiving visual feedback.

The invention provides a control system for control of a user-controllable apparatus. The system comprises a generator for supplying data to enable display of a control menu of the apparatus on a display monitor. The generator may be integrated with the apparatus. The system has a first interface coupled between the generator and a data network for enabling the data to be transmitted to a remote location. The system has also a second interface coupled between the data network and the apparatus for receipt of a user command from the remote location via the data network for control of the apparatus. The first and/or the second interface may comprise a home server local to the apparatus. The second interface may comprise an IR (or RF) blaster under control of the home server.

The invention makes use of apparatus (which may be commercially available) that have or can be made to cooperate with a generator to generate data for an on-screen control menu for user-control of the apparatus with visual feedback. For example, VCR's or HDD-based video recorders in operational use are typically connected to a TV receiver. The TV's display monitor is used for display of the recorder's control menu from which the user makes his/her selections to program or otherwise operate the recorder via a suitable remote. A video-capture device can be connected to an extra video-out plug on the VCR or to a video splitter if the VCR has only a single video output. As a result, the same menus that are shown on the TV display monitor can be redirected to a computer or a set top box as an image or multiple images. The images can be optionally displayed at a remote location using an interface to the data network. The apparatus, here the recorder, provides visual feedback through its menu communicated via the data network to a remote location. In conjunction with a CGI-driven IR blaster local to the apparatus and an interface, the apparatus can be controlled via the data network from the remote location through the IR blaster.

### BRIEF DESCRIPTION OF THE DRAWINGS

The above and other objects, features and advantages of the present invention will become more apparent in light of the following detailed description of an exemplary embodiment thereof taken in conjunction with the attached drawings in which:

FIG. 1 is a block diagram illustrating a remote control system in accordance with the present invention; and

FIG. 2 is a flow chart illustrating a method of remotely controlling a CE device in accordance with the present invention.

### DETAILED DESCRIPTION OF THE PREFERRED EMBODIMENT

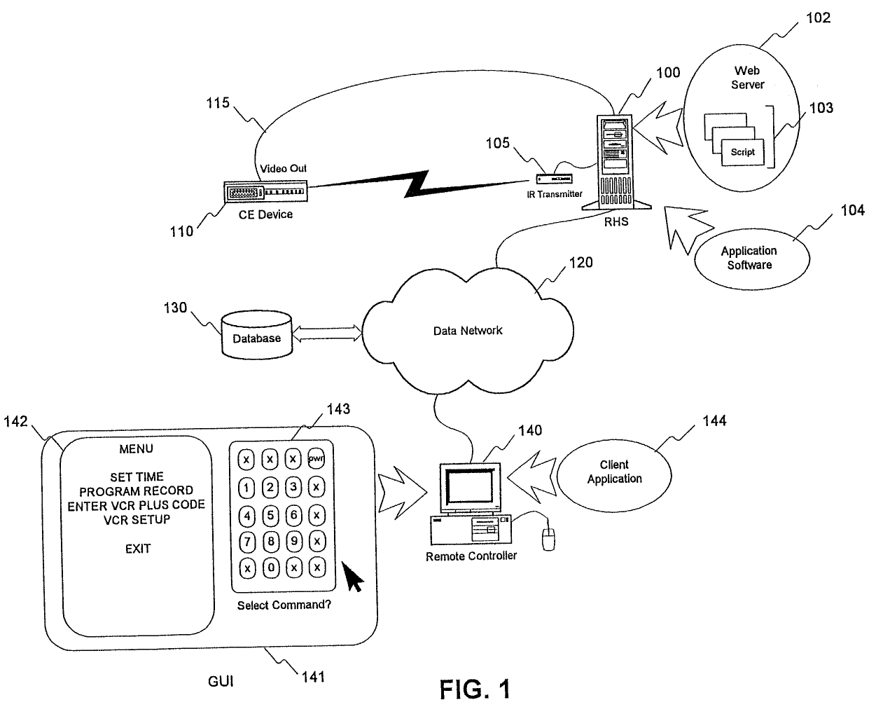

Turning now to the drawings, in which like reference numerals identify similar or identical elements throughout the several views, a remote control system in accordance with the present invention is illustrated in FIG. 1.

Referring to FIG. 1, a preferred embodiment of the remote control system of the present invention includes an apparatus or device controller, such as a Reliable Home Server (RHS) 100. RHS 100 may be a server application running on a home PC or other server or may be a separate low-cost server such as a set top box. Web Server 102 and scripts 103 are software components of RHS 100 or may alternatively be on a separate server communicating with RHS 100. That is, although RHS 100 is shown and described herein as a computer running a server application, it is understood by one of ordinary skill in the art that RHS 100 may also be realized by a client application stored on a computer communicating with a server via a data network.

In a preferred embodiment, RHS 100 comprises a PC running an Apache Web server 102. RHS 100 further comprises software modules that preferably include common gateway interface (CGI) scripts 103 run by web server 102. CGI is part of the HTTP protocol and provides a specification for transferring information back and forth between a web server and an application.

A CE device communication module 105 communicates with RHS 100 via a cable or other suitable means known in the art, i.e., wireless communications. In the illustration of FIG. 1, an IR transmitter 105, such as an IR blaster, is shown connected to RHS 100 via a cable. The IR transmitter 105 communicates with RHS 100 via a serial communications port, for example, using an RS-232 communications protocol under the control of IR transmitter application software 104, which is a software component of RHS 100. As discussed above, the IR transmitter 105 application software 104 learns the IR communication characteristics of a remote control for a CE device 110 and once learned can transmit the appropriate IR signal to the CE device 110 upon receipt of an appropriate input command from RHS 100. The application software 104 may also contain a database of available IR communication characteristics, or alternatively, may access a remote database 130 via the data network 120 as discussed further below. Multiple CE devices 110 may be controlled in this fashion.

For example, a VCR 110 is illustrated as the CE device 110 in FIG. 1. In such a case, in a simple embodiment, the user may hold a remote control for the VCR 110 up to IR transmitter 105 to allow the application software 104 to learn the IR communication characteristics. In a more sophisticated embodiment, the application software loaded into RHS 100 includes a database of all CE devices along with their IR communication characteristics. The application software 104 provides a menu to the user, for example, on a display device connected to the RHS 100, to select the corresponding CE device he/she will be controlling.

Other communication modules 105 may also be employed, such as X-10 modules, HAVi/1394, Jini and UPnP for instance. In any case, the application software 104 is customized to control the corresponding communication module 105 to operatively communicate with RHS 100 and control CE device 110.

RHS 100 also includes hardware to capture a video image from an external video source. For example, RHS 100 may be a home PC with a video capture card. A video image signal, for example a menu screen, is transmitted to RHS 100 from CE device 110 via, for example, cable 115, and stored at RHS 100 for use by the application software 104. Other wireless transfers may also be implemented.

Remote controller 140 communicates with RHS 100 via a two-way communication link over a data network 120. For example, as illustrated, remote controller 140 may be a PC communicating with RHS 100 via the Internet in a client/server relationship. That is, remote controller 140 is preferably a PC with a client application 144, such as a web browser, for communicating with the web server 102 via the Internet. The two-way communication may optionally be encrypted for added security.

Remote controller 140 includes a graphical user interface (GUI) 141 which, for example, displays video received from RHS 100 in a visual feedback window 142. The video received from RHS 100 may be, for example, video images transmitted to the RHS 100 from the CE device 110, as described above. A command control portion 143 provides user interface to the CE device 110. That is, command control portion 143 of GUI 141 may, for example, receive and display a graphical image of a remote control for the CE device corresponding to the video images received from the RHS 100, which are simultaneously displayed in the visual feedback window 142. This allows a user, using a mouse pointer for example, to simply click on the buttons of the graphical remote control. The user may then receive visual feedback via video images sequentially captured by the RHS 100 from the CE device 110, which are then transmitted to remote controller 140 and displayed in visual feedback window 142. The video images change in response to commands entered in the command control portion 143, as described further below. The video images are preferably captured directly from a video output of the CE device 110. Alternatively, the images may be captured from a video camera (not shown) monitoring a control panel of the CE device, for example.

In an alternative embodiment, the application software 104 includes the capabilities for performing optical character recognition (OCR) on the captured images. That is, the captured images are converted to text characters and transmitted as text for display on a two-way pager, for example. The text may additionally be converted to speech, as an audio stream, with the audio stream being transmitted to a cellular phone, for instance.

In either case, the two-way communication link may be realized via a wireless network, with the remote controller 140 being a wireless device, such as a two-way pager or cellular phone, for example, the GUI 141 may then be realized via a display screen of the wireless device. The RHS 100 may also translate the control commands received from the wireless device and control CE device using the application software 104.

The OCR may optionally access a database 130 storing known menu screens for each CE device, thereby requiring only brief translations and/or status messages, such as “VCR programmed successfully” or “there was an error”. The database 130 may also store macros for common command sequences, thereby increasing user convenience. This feature is especially useful when the remote controller 140 is a wireless device with a limited user interface.

Alternatively, the wireless device configuration may be utilized to receive confirmation messages whenever a CE device is remotely controlled. For example, when a remote control session is initiated, or terminated, a confirmation message may be forwarded to a pager, cellular phone, email, etc., such as “someone has remotely programmed the VCR”. This provides additional security to a user, in cases of tampering.

The GUI 141 is driven by web server 102, which derives control information and video images from the application software 104 via the CGI scripts 103. Client application 144 retrieves the data from web server 102 via data network 120, pursuant to their client/server relationship.

A database 130 may optionally be incorporated to store data, which simplifies command control of the CE device 110. For example, in the case of a VCR, web server 102 may access a VCR Plus™ database 130 to display a list of broadcast programs along with the VCR Plus™ codes, or may access an electronic program guide such as program guide used by TiVo™ with its HDD-based video recorder. A user may then view this list in the command control portion of the GUI 141 and select the desired broadcast program to record. The client application 144 then automatically transmits the corresponding selection to web server 102 via data network 120. Application software 104 receives the selected code via CGI scripts 103 and transmits the code to VCR 110 via IR transmitter 105. Thus, the remote control process is simplified.

Database 130 may reside anywhere on data network 120, including in the RHS 100 or remote controller 140.

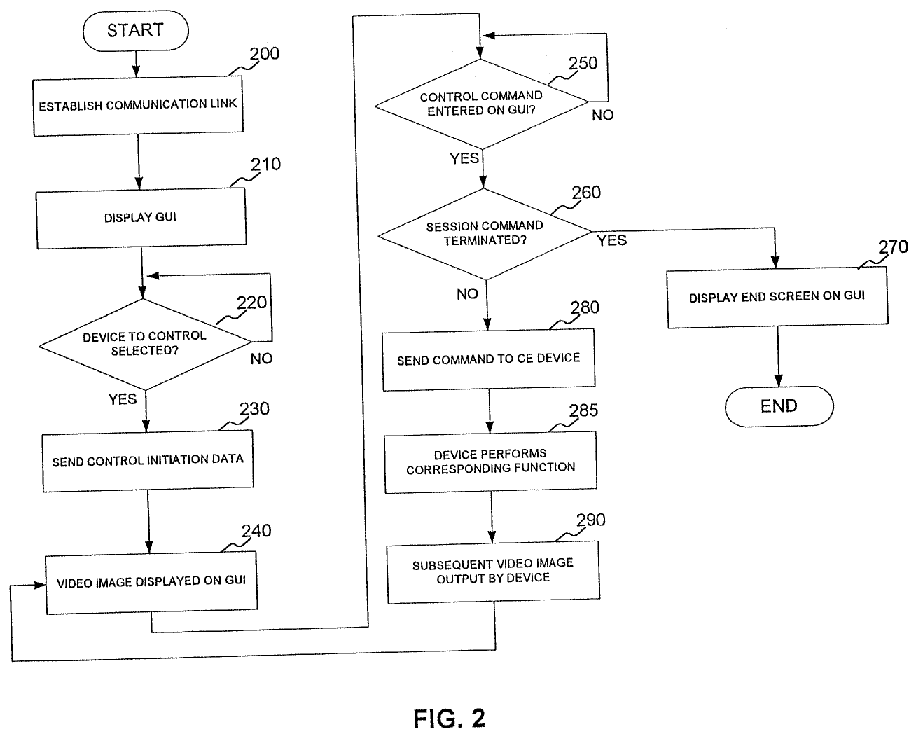

With reference now to FIG. 2, in operation, a user first initiates communications between a remote controller 140 and an apparatus or device controller (such as RHS) 100 via communication link over data network 120, in step 200. A GUI 141 is displayed to a user at the remote controller 140 in step 210. A CE device to be controlled is selected via the GUI 141 in step 220. Control initiation data is transmitted from the apparatus controller 100 to the CE device 110 in step 230. This prompts CE device 110 to output an initial video image which is captured by apparatus controller 100 via cable 115 and transmitted to remote controller 140 via data network 120 for display on GUI 141 in step 240. A user then enters a control command via GUI 141, in response to the initial video image displayed, in step 250. Here, the command may simply instruct the CE device to display a submenu, carry out a function, or terminate the remote control session. In step 260, it is determined whether a “terminate session” command was entered by a user in step 250, and, if so, an end screen is displayed at GUI 141 in step 270 and the session ends.

If, however, the command entered in step 260 is other than a terminate-session command, the command is transmitted to CE device 110 via the remote controller 140, data network 120, and apparatus controller 100 in step 280. The apparatus carries out the corresponding function in step 285 and outputs a subsequent video image corresponding to a subsequent decision/function in step 290. The subsequent video image is transmitted to remote controller 140 via apparatus controller 100 and data network 120, and displayed on GUI 141 in step 240, thereby providing visual feedback to the user. Steps 240 to 290 are repeated until a terminate session command is input in step 250, as determined in step 260.

This procedure is repeated for each apparatus a user wishes to control.

Accordingly, the present invention advantageously allows remote control of a CE device 110 with visual feedback over a data network 120.

In an alternative embodiment, an aspect of the invention is implemented as a Software (SW) application. Consider a user who has a set-top box (STB) or a PC with Internet access, a VCR or another CE device that has a generator for generating an on-screen GUI, an IR blaster or RF transmitter, and a video capture device. The video capture device is connected to a video-output of the VCR or the other CE device. An STB has a cable input, which can be routed via the VCR so, e.g., channel 3 is taken over by the VCR if it is remotely turned on. If a PC is used instead of an STB, it can be supplied with a video capture device or card. A software application can then be installed on the PC or STB that captures the data from the generator, and allows the user to retrieve the data through the Internet while also enabling remote driving of the IR blaster or RF transmitter via the PC or STB.

In an alternative embodiment, a simple VCR, e.g., one that is manually programmable via IR codes, is used. The user has access to an Electronic Program Guide (EPG) via his/her PC or STB. The EPG, normally displayed at the TV receiver's monitor is captured (within the electronic signal domain) and is made accessible to a remote location via the data network, e.g., the Internet. Through the EPG, the user can identify from the remote location those broadcasts that he/she would like to have recorded. The user's home network comprises an STB or PC that has appropriate software or processing to drive an IR blaster with the proper codes to control the programming of the simple VCR, for example, through scripts to facilitate the programming process. Thus, the user specifies to the STB or PC (or another piece of equipment that is capable to function as a server) the programs to be recorded in the EPG. The STB or PC then runs a script to set the proper turn-on and turn-off times and channels via control of the IR blaster. Any IR or RF controllable piece of CE equipment may be used with this embodiment, wherein the user communicates the commands, via the Internet or other data network, from a remote location to a server in the home. The server then activates a script or otherwise causes the appropriate IR or RF commands to be sent via a local transmitter or blaster. In the absence of two-way communication in the control path for the piece of equipment, visual (or other) feedback can be initiated by the PC or STB and transmitted to the user through the data network, thus confirming that the proper commands where issued to the CE device.

In another embodiment of the invention, a service provider makes available an EPG via the Internet or another data network. The user of a home network subscribes to this service. The service provider requests at the registering a profile of the A/V (audio/video) equipment on the home network, including the types, brands and serial numbers of the apparatus and/or control software applications that may interface with the Internet. The service provider then downloads control codes and scripts relating to the EPG to the STB or PC. This allows the user to drive an IR blaster or RF transmitter from a PC or STB for control of the equipment. In addition, the user may retrieve the EPG from the service provider while at a remote location and interact with the EPG through a simple GUI. Simple user commands created through the GUI are transmitted through the Internet or data network to the home network and activate the proper equipment on the user's home network through the appropriate scripts. This scenario enables, for example, to activate from a remote location a video recorder (VCR or HDD-based) based on EPG information. The service could be for free, in return for the user's equipment profile. The profile is obtained from the user to customize the scripts and applications. The service provider or another third party can use this profile for targeted electronic advertisement.

The invention can be implemented, for example, as a client-server architecture, wherein the user is enabled to retrieve the control menu from the home server for display at his/her client, e.g., a Personal Digital Assistant (PDA) with a browser and a wireless modem, or a laptop. Alternatively, the client can be a cell phone with an LCD display monitor and proper GUI software.

The following documents are hereby incorporated herein by reference:

(1) Co-pending U.S. Ser. No. 09/271,200 (attorney docket PHA 23,607) filed Mar. 17, 1999 for Jan van Ee for FULLY FUNCTIONAL REMOTE CONTROL EDITOR AND EMULATOR. This document relates to a universal programmable remote control device. The device has programmability functions that enable the end-user to customize the device through editing or programming the device's control functionalities. The programming can be achieved via a PC. The control configuration created via an editor on the PC can be downloaded into the device. The PC has emulator software to test the configuration before downloading. The emulator software and the remote's control software are made identical as a consequence of a software layer that abstracts from the remote's hardware. The emulator for the end-user is thus obtained as an almost free byproduct of the software development phase at the manufacturer.

(2) Co-pending U.S. Ser. No. 09/427,821 (attorney docket PHA 23,786) filed Oct. 27, 1999 for Joost Kemink and Rik Sagar for PDA HAS WIRELESS MODEM FOR REMOTE CONTROL VIA THE INTERNET. This document relates to an information processing system that has a handheld computing device, e.g., a PDA, with a user-interface and a wireless modem coupled to the handheld device. The wireless modem enables communication with a server via a data network such as the Internet. A control network is coupled between the server and controllable equipment. The handheld is thus capable of functioning as a wireless remote control device for the equipment via the Internet and the server. The system may comprise a video camera together with hardware and software to create a formatted still image suitable for being displayed on the handheld device. The user can thus instruct retrieval of a still image from the server via the Internet. This application serves as, e.g., a security system that enables the remote user to monitor his/her front porch, or to monitor a child by way of a remote (or fall-back) baby-sit. The user-accessibility of equipment is guaranteed by the ubiquity of the Internet, thus enabling to expand the range of control and monitoring capabilities for a mobile user.

(3) Co-pending U.S. Ser. No. 09/434,155 (attorney docket PHA 23,783) filed Nov. 4, 1999 for Martin Freeman and Bonghan Cho for REMOTE INITIATES RETRIEVAL OF CONTROL CONFIGURATION. This document relates to a remote control device that initiates retrieval of a pre-defined control configuration from a repository. For example, a reference or default control mode is backed up so that the user can always return to a reference configuration without too much effort. This default or reference mode is either stored in the remote by the manufacturer or retailer, or it comprises a user-programmed configuration that is downloaded from the device to an external repository, e.g., the user's PC, for retrieval later on when desirable in a communication procedure initiated by the remote. Alternatively, or subsidiarily, the apparatus to be controlled serves as a repository for the control configuration of the apparatus itself. The remote retrieves the configuration from the apparatus if and when needed. In this manner the remote is made highly user-friendly and truly universal, serving as a mobile interface to nearby equipment.

(4) Co-pending U.S. Ser. No. 09/160,490 (attorney docket PHA 23,500) filed Sep. 25, 1998 for Adrian Turner et al., for CUSTOMIZED UPGRADING OF INTERNET-ENABLED DEVICES BASED ON USER-PROFILE. This document relates to a SmartConnect (TM) server system that maintains a user profile of a particular end-user of consumer electronics network-enabled equipment. The server also maintains a data base of new technical features for this type of equipment. If there is a match between the user-profile and a new technical feature, and the user indicates to receive information about updates or sales offers, the user gets notified via the network of the option to obtain the feature.

(5) Co-pending U.S. Ser. No. 09/189,535 (Attorney docket PHA 23,527) filed Nov. 10, 1998 for Eugene Shteyn for UPGRADING OF SYNERGETIC ASPECTS OF HOME NETWORKS. This document relates to a server that has access to an inventory of devices and capabilities on a user's home network. The inventory is, for example, a look-up service as provided by HAVi or Jini architecture. The server has also access to a data base with information of features for a network. The server determines if the synergy of the apparatus present on the user's network can be enhanced based on the listing of the inventory and on the user's profile. If there are features that are relevant to the synergy, based on these criteria, the user gets notified.

While the present invention has been described in detail with reference to the preferred embodiments, they represent mere exemplary applications. For example, while a VCR has primarily been used to illustrate an example of controlling at least one CE device, any CE device may be controlled, where the CE device preferably has a video output. Thus, it is to be clearly understood that many variations can be made by anyone having ordinary skill in the art while staying within the scope and spirit of the present invention as defined by the appended claims.

What is claimed is:

1. A control system for user control of an apparatus, wherein the system comprises:
a generator for supplying data to enable display of a control menu for control of the apparatus on a display monitor;
a first interface coupled between the generator and a data network for enabling the data to be transmitted to a remote location;
a second interface coupled between the data network and the apparatus for receipt of a user command from the remote location via the data network for control of the apparatus.

2. The system of claim 1, wherein the generator is integrated with the apparatus.

3. The system of claim 2, wherein:
the apparatus comprises a video recording device; and
the first interface comprises a video capture device.

4. The system of claim 1, wherein the first interface comprises a home server.

5. The system of claim 1, wherein the second interface comprises a home server

6. The system of claim 1, wherein the second interface comprises an IR blaster.

7. The system of claim 1, wherein the second interface comprises an RF blaster.

8. A software application for running on a home server to enable user remote control of an apparatus, the application redirecting data for an on-screen menu for control of the apparatus to a remote location on a data network.

9. The application of claim 8, comprising control script for driving an IR blaster local to the apparatus.

10. The application of claim 8, comprising a control script for driving an RF transmitter local to the apparatus.

11. A method of enabling a user to control an apparatus from a remote location via a data network, comprising:
enabling the user to retrieve a control menu via a data network for control of the apparatus via a display monitor; and
enabling an interaction of the user with the control menu to cause, via the data network, an associated command to be sent to the apparatus from a transmitter local to the apparatus.

12. The method of claim 11, wherein:
the apparatus is controllable via a server local to the apparatus; and
the enabling of an interaction of the user with the control menu also causes, via the data network, the activating of a script residing on the server.

13. The method of claim 12, wherein the script is customized.

14. The method of claim 11, wherein:
the apparatus is controllable via a server local to the apparatus; and
the enabling of an interaction of the user with the control menu also causes, via the data network, the supplying of an input to a software application running on the server.

15. The method of claim 14, wherein the application is customized.
